(19) United States
(12) Patent Application Publication
(10) Pub. No.: US 2024/0186578 A1
(43) Pub. Date: Jun. 6, 2024

(54) ELECTROLYTE FOR LITHIUM SECONDARY BATTERY AND LITHIUM SECONDARY BATTERY INCLUDING THE SAME

(71) Applicant: Samsung SDI Co., Ltd., Yongin-si (KR)

(72) Inventors: Hana Ra, Yongin-si (KR); Taejin Lee, Yongin-si (KR); Minseo Kim, Yongin-si (KR); Myungheui Woo, Yongin-si (KR); Hyejin Park, Yongin-si (KR); Bokyung Ryu, Yongin-si (KR)

(21) Appl. No.: 18/484,331

(22) Filed: Oct. 10, 2023

(30) Foreign Application Priority Data
Nov. 14, 2022 (KR) 10-2022-0151990

(51) Int. Cl. H01M 10/0567; H01M 10/0568; H01M 10/0569; H01M 10/42

(52) U.S. Cl. CPC H01M 10/0567; H01M 10/0568; H01M 10/0569; H01M 10/4235; H01M 10/052

(57) ABSTRACT

An electrolyte for a lithium secondary battery and a lithium secondary battery including the electrolyte are provided. The electrolyte for a lithium secondary battery may include a lithium salt, an organic solvent, and an additive represented by Formula 1, where at least one selected from among R₁ to R₆ may be a C1-C5 alkyl group including a cyano group, and one or two selected from among R₁ to R₆ may each be a fluorinated C1-C5 alkyl group.

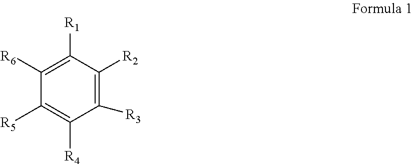

### CROSS-REFERENCE TO RELATED APPLICATION

This application claims priority to and the benefit of Korean Patent Application No. 10-2022-0151990, filed on Nov. 14, 2022, in the Korean Intellectual Property Office, the content of which is incorporated by reference herein in its entirety.

### BACKGROUND

### 1. Field

One or more embodiments of the present disclosure relate to an electrolyte for a lithium secondary battery and a lithium secondary battery including the electrolyte.

### 2. Description of the Related Art

Lithium secondary batteries have three or more times higher energy density per unit weight than existing lead-acid batteries, nickel-cadmium batteries, nickel-metal hydride batteries, and/or nickel-zinc batteries and are capable of being charged at a high speed.

Lithium secondary batteries should be stable within a battery operating voltage range and should maintain safety even beyond the operating voltage range. However, in some lithium secondary batteries, lithium excessively flows out of a positive electrode and excessively flows into a negative electrode under an overcharge and overvoltage environment. Thus, both (e.g., simultaneously) the positive and the negative electrode are in an unstable state under the overcharge and overvoltage environment.

In order to solve the problem and/or issue due to such an overcharge and overvoltage environment, one or more additives are added to an electrolyte, resulting in some degradation in performance of a lithium secondary battery.

Therefore, it is desirable to improve safety by improving overcharge characteristics of lithium secondary batteries while providing suitable performance.

### SUMMARY

One or more aspects of embodiments of the present disclosure are directed toward an electrolyte for a lithium secondary battery which includes a electrolyte additive.

One or more aspect of embodiments of the present disclosure are directed toward a lithium secondary battery including the electrolyte.

Additional aspects will be set forth in part in the description which follows and, in part, will be apparent from the description, or may be learned by practice of the presented embodiments of the disclosure.

According to one or more embodiments of the present disclosure,
an electrolyte for a lithium secondary battery includes a lithium salt,
an organic solvent, and
an additive represented by Formula 1:

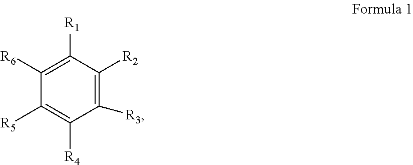

wherein, in Formula 1, at least one selected from among R₁ to R₆ may be a C1-C5 alkyl group including a cyano (CN) group,
one or two selected from among R₁ to R₆ may each be a fluorinated C1-C5 alkyl group, and
the remainder of R₁ to R₆ are independently hydrogen, a substituted or unsubstituted C1-C5 alkyl group, a substituted or unsubstituted C2-C10 alkenyl group, a substituted or unsubstituted C2-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

According to one or more embodiments of the present disclosure,
a lithium secondary battery includes a positive electrode which includes a positive electrode active material,
a negative electrode which includes a negative electrode active material, and
the above-described electrolyte between the positive electrode and the negative electrode.

### BRIEF DESCRIPTION OF THE DRAWINGS

The accompanying drawings are included to provide a further understanding of the present disclosure and are incorporated in and constitute a part of the present disclosure. The drawings illustrate embodiments of the present disclosure and, together with the description, serve to explain principles of the present disclosure. The above and other aspects, features, and advantages of certain embodiments of the disclosure will be more apparent from the following description taken in conjunction with the accompanying drawings, in which:

FIG. 1 is a schematic view of a lithium secondary battery according to one or more embodiments of the present disclosure; and

FIG. 2 shows results of a linear sweep voltammetry test on three-electrode beaker cells utilizing electrolytes according to Examples 1 and 2 and Comparative Example 1 according to one or more embodiments of the present disclosure.

### DETAILED DESCRIPTION

Reference will now be made in more detail to embodiments, examples of which are illustrated in the accompanying drawings, wherein like reference numerals refer to like elements throughout the present disclosure, and duplicative descriptions thereof may not be provided for conciseness. In this regard, the embodiments of the present disclosure may have different forms and should not be construed as being limited to the descriptions set forth herein. Accordingly, the embodiments of the present disclosure are merely described, by referring to the drawings, to explain aspects of the present disclosure. As utilized herein, the term “and/or” or “or” may include any and all combinations of one or more of the associated listed items. Expressions such as “at least one of,” and “one of,” when preceding a list of elements, modify the entire list of elements and do not modify the individual elements of the list.

Hereinafter, an electrolyte for a lithium secondary battery and a lithium secondary battery including the electrolyte will be described in more detail with reference to embodiments and drawings of the present disclosure. It should be understood by one of ordinary skill in the art that these embodiments provided only for more specific illustration of the present disclosure and are not to be construed as limiting the scope of the present disclosure.

Unless otherwise defined, all technical and scientific terms utilized herein have the same meanings as commonly understood by one of ordinary skill in the art to which the present disclosure pertains. In case of conflict, the present disclosure, including definitions, will control.

Although any methods and materials similar or equivalent to those described herein can be utilized in the practice or testing of embodiments of the disclosure, suitable methods and materials are described herein. A singular form may include a plural form if (e.g., when) there is no clearly opposite meaning in the context.

As utilized herein, it is to be understood that the terms such as “including,” “having,” and “comprising” are intended to indicate the existence of the features, numbers, steps, actions, components, parts, ingredients, materials, or combinations thereof disclosed in the specification, and are not intended to preclude the possibility that one or more other features, numbers, steps, actions, components, parts, ingredients, materials, or combinations thereof may exist or may be added.

It will be understood that the term “a combination thereof” as utilized herein refers to a mixture or combination inclusive of two or more components.

As utilized herein, the term “and/or” includes any and all combinations of one or more of the associated listed items. As utilized herein, the term “or” refers to the term “and/or.” As utilized herein, the expression “at least one species,” “at least one,” or “one or more” in front of elements refers to that the expression may complement the entire list of elements and does not refer to that the expression may complement individual elements described above.

In the drawings, the thickness of layers, films, panels, regions, and/or the like may be exaggerated for clarity. Like reference numerals designate like elements throughout the present disclosure, and duplicative descriptions thereof may not be provided. It will be understood that when an element such as a layer, film, region, or substrate is referred to as being “on” another element, it can be directly on the other element or intervening elements may also be present. It will be understood that, although the terms “first,” “second,” and “third” may be utilized herein to describe one or more suitable elements, elements should not be limited by these terms. These terms are only utilized to distinguish one element from another element.

In general, an overcharge property improving additive has a structure including a biphenyl group. When the overcharge property improving additive is included in an electrolyte, in a lithium secondary battery including the additive, even within a normal operating voltage range, electrolyte decomposition may start, which may increase internal resistance of a cell and degrade performance such as life characteristics of the battery.

According to one or more embodiments, an electrolyte for a lithium secondary battery may include a lithium salt, an organic solvent, and an additive represented by Formula 1.

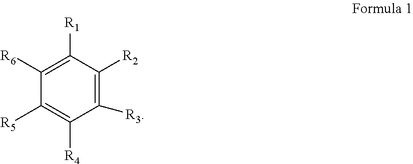

In Formula 1, at least one selected from among R₁ to R₆ may be a C1-C5 alkyl group including a cyano (CN) group,
one or two selected from among R₁ to R₆ may each be a fluorinated C1-C5 alkyl group, and
the remainder of R₁ to R₆ may each independently be hydrogen, a substituted or unsubstituted C1-C5 alkyl group, a substituted or unsubstituted C2-C10 alkenyl group, a substituted or unsubstituted C2-C10 alkynyl group, a substituted or unsubstituted C3-C20 cycloalkyl group, a substituted or unsubstituted C6-C50 aryl group, a substituted or unsubstituted C6-C50 alkylaryl group, or a substituted or unsubstituted C6-C50 heteroaryl group.

In Formula 1, in some embodiments, one or two selected from among R₁ to R₆ may each be a C1-C5 alkyl group including a CN group.

Non-limiting examples of the C1-C5 alkyl group including the CN group may include —CH₂CN, —CH₂CH₂CN, —CH₂CH₂CH₂CN, and/or the like. Non-limiting examples of the fluorinated C1-C5 alkyl groups may include CF₃ and C₂F₅.

The additive represented by Formula 1 may include the C1-c5 alkyl group including the CN group to protect a surface of a positive electrode, thereby contributing to structural stabilization of the positive electrode. Because the additive represented by Formula 1 has a structure in which a phenyl group is substituted with the fluorinated C1-C5 alkyl group, the additive may have excellent or suitable flame retardancy and may be preferentially oxidized, thereby serving to suppress or reduce a voltage rise of a battery in a high voltage environment.

As described above, because the electrolyte for a lithium secondary battery according to one or more embodiments includes the additive represented by Formula 1, a film may be formed on a positive electrode to protect the positive electrode under an overcharge and overvoltage environment, and the electrolyte may start to be decomposed at a voltage of about 4.5 V or more, thereby suppressing a voltage rise of a battery in an overcharge environment to prevent or reduce electrolyte decomposition. Accordingly, in a lithium secondary battery including the electrolyte, it may improve overcharge characteristics and improve safety, and maintain performances such as high-temperature life characteristics or minimize or reduce degradation in the performances.

In one or more embodiments, the additive may be at least one selected from compounds represented by Formulas 1-1 to 1-4.

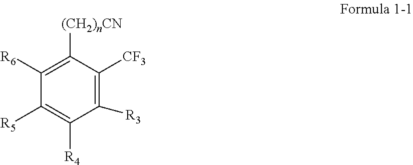

In Formula 1-1, R₃ to R₆ may each independently be hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n may be an integer from 1 to 4.

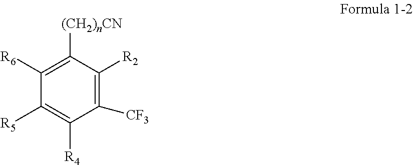

In Formula 1-2, R₂ and R₄ to R₆ may each independently be hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n may be an integer from 1 to 4.

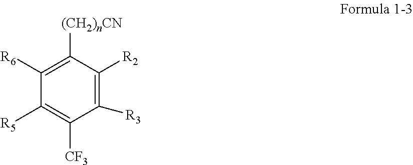

In Formula 1-3, R₂, R₃, R₅, and R₆ may each independently be hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n may be an integer from 1 to 4.

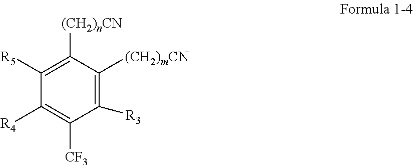

In Formula 1-4, R₃, R₄, and R₅ may each independently be hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n and m may each independently be an integer of 1 to 4.

In Formula 1-1, in some embodiments, R₃ to R₆ may all be, for example, hydrogen.

In Formula 1-2, in some embodiments, R₂ and R₄ to R₆ may all be, for example, hydrogen.

In Formula 1-3, in some embodiments, R₂, R₃, R₅, and R₆ may all be hydrogen, and in Formula 1-4, in some embodiments, R₃, R₄, and R₅ may all be hydrogen.

In one or more embodiments, the additive represented by Formula 1 may be, for example, at least one selected from Compounds A to I.

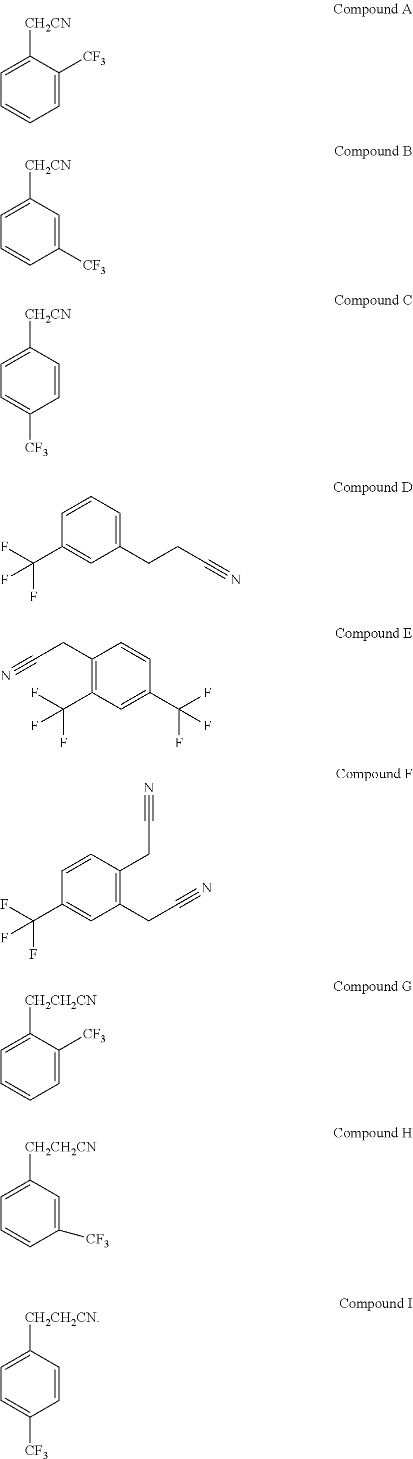

A content (e.g., amount) of the additive represented by Formula 1 may be in a range of about 0.1 wt % to about 10 wt %, about 0.3 wt % to about 10 wt %, about 0.5 15 wt % to about 10 wt %, about 1 wt % to about 10 wt %, about 1 wt % to about 7 wt %, about 1 wt % to about 7 wt %, about 1 wt % to about 5 wt %, or about 1 wt % to about 4 wt %, with respect to about 100 wt % of the total weight of the electrolyte. When the content (e.g., amount) of the additive is within the above range, a positive electrode may be protected in a high temperature environment to increase a lifetime of the positive electrode and improve overcharge characteristics.

According to one or more embodiments, the lithium salt may include at least one selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), and compounds represented by Formulas 2 to 5, but embodiments of the present disclosure are not limited thereto. Any material usable as a lithium salt in the art may be utilized.

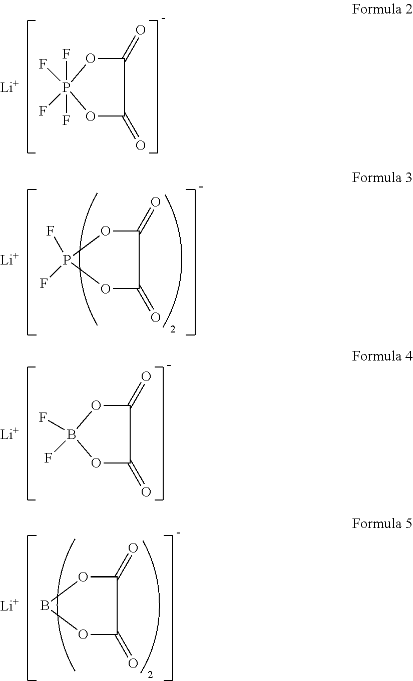

A concentration of the lithium salt in the electrolyte may be in a range of about 0.1 M to about 5.0 M, for example, a range of about 0.1 M to about 3.0 M, or about 0.1 to about 2.0 M. When the concentration of the lithium salt is within the above range, it may obtain further improved characteristics of a lithium secondary battery.

The organic solvent may be at least one selected from a carbonate-based solvent, an ester-based solvent, an ether-based solvent, and a ketone-based solvent.

The carbonate-based solvent may include ethyl methyl carbonate (EMC), methyl propyl carbonate (MPC), ethyl propyl carbonate (EPC), dimethyl carbonate (DMC), diethyl carbonate (DEC), dipropyl carbonate (DPC), propylene carbonate (PC), ethylene carbonate (EC), butylene carbonate (BC), and/or the like.

The ester-based solvent may include methyl propionate, ethyl propionate, ethyl butyrate, methyl acetate, ethyl acetate, n-propyl acetate, dimethyl acetate, gamma butyrolactone, decanolide, gamma valerolactone, mevalonolactone, caprolactone, and/or the like. The ether-based solvent may include dibutyl ether, tetraglyme, diglyme, dimethoxyethane, 2-methyl tetrahydrofuran, tetrahydrofuran, and/or the like. The ketone-based solvent may include cyclohexanone and/or the like. The nitrile-based solvent may include acetonitrile (AN), succinonitrile (SN), adiponitrile, and/or the like. Other suitable solvents may include dimethylsulfoxide, dimethylformamide, dimethylacetamide, tetrahydrofuran, and/or the like, but embodiments of the present disclosure are not necessarily limited thereto. Any material utilized as an organic solvent in the art may be utilized. For example, the organic solvent may include a mixed solvent of about 50 vol % to about 95 vol % of chain carbonate and about 5 vol % to about 50 vol % of cyclic carbonate, for example, a mixed solvent of about 70 vol % to about 95 vol % of chain carbonate and about 5 wt % to about 30 vol % of cyclic carbonate. For example, the organic solvent may be a mixed solvent of three or more organic solvents.

According to one or more embodiments, the organic solvent may include at least one selected from EMC, MPC, EPC, DMC, DEC, DPC, PC, EC, fluoroethylene carbonate (FEC), vinylene carbonate (VC), vinylethylene carbonate (VEC), butylene carbonate, ethyl propionate, ethyl butyrate, dimethyl sulfoxide, dimethylformamide, dimethylacetamide, gamma-valerolactone, gamma-butyrolactone, and tetrahydrofuran, but embodiments of the present disclosure are not limited thereto. Any material utilized as an organic solvent in the art may be utilized.

The electrolyte may be in a liquid or gel state. The electrolyte may be prepared by adding the lithium salt and the above-described additive to the organic solvent.

According to one or more embodiments, a lithium secondary battery may include a positive electrode including a positive electrode active material, a negative electrode including a negative electrode active material, and the above-described electrolyte between the positive electrode and the negative electrode.

According to one or more embodiments, a lithium (secondary) battery may include a positive electrode including a positive electrode active material, a negative electrode including a negative electrode active material, and the above-described electrolyte between the positive electrode and the negative electrode.

Because the lithium secondary battery includes the additive of the above-described electrolyte for a lithium secondary battery, an increase in initial resistance of the lithium secondary battery may be suppressed or reduced, generation of gas due to a side reaction may be suppressed or reduced, and life characteristics of the battery may be improved.

In one or more embodiments, the positive electrode active material may include a lithium transition metal oxide including nickel and other transition metal(s). A content (e.g., amount) of nickel in the lithium transition metal oxide including nickel and other transition metal(s) may be about 60 mol % or more, for example, about 75 mol % or more, about 80 mol % or more, about 85 mol % or more, or about 90 mol % or more, with respect to the total number of moles of the transition metals in the lithium transition metal oxide.

For example, in some embodiments, the lithium transition metal oxide may be a compound represented by Formula 7:

LiₐNiₓCo_{y}M_{z}O_{2-b}A_{b}. Formula 7

In Formula 7, 1.0≤a≤1.2, 0≤b≤0.2, 0.6≤x<1, 0<y≤0.3, 0<z≤0.3, x+y+z=1, M may be at least one selected from manganese (Mn), vanadium (V), magnesium (Mg), gallium (Ga), silicon (Si), tungsten (W), molybdenum (Mo), iron (Fe), chromium (Cr), copper (Cu)), zinc (Zn), titanium (Ti), aluminum (Al), and boron (B), and A may be F, S, Cl, Br, or a combination thereof.

In Formula 7, for example, 0.7≤x<1, 0<y≤0.3, 0<z≤0.3; 0.8≤x<1, 0<y≤0.3, and 0<z≤0.3; 0.8≤x<1, 0<y≤0.2, and 0<z≤0.2; 0.83≤x<0.97, 0<y≤0.15, and 0<z≤0.15; or 0.85x≤0.95, 0<y≤0.1, and 0<z≤0.1.

For example, in one or more embodiments, the lithium transition metal oxide may be at least one selected from compounds represented by Formulas 8 and 9.

LiNiₓCo_{y}Mn_{z}O₂ Formula 8

In Formula 8, 0.6≤x≤0.95, 0<y≤0.2, and 0<z≤0.1. For example, 0.7≤x≤0.95, 0<y≤0.3, and 0<z≤0.3.

LiNiₓCo_{y}Al_{z}O₂ Formula 9

In Formula 9, 0.6≤x≤0.95, 0<y≤0.2, and 0<z≤0.1. For example, 0.7≤x≤0.95, 0<y≤0.3, and 0<z≤0.3. For example, 0.8≤x≤0.95, 0<y≤0.3, and 0<z≤0.3. For example, 0.82≤x≤0.95, 0<y≤0.15, and 0<z≤0.15. For example, 0.85≤x≤0.95, 0<y≤0.1, and 0<z≤0.1.

For example, in one or more embodiments, the lithium transition metal oxide may be LiNi_{0.6}Co_{0.2}Mn_{0.2}O₂, LiNi_{0.88}Co_{0.08}Mn_{0.04}O₂, LiNi_{0.8}Co_{0.15}Mn_{0.05}O₂, LiNi_{0.8}Co_{0.1}Mn_{0.1}O₂, LiNi_{0.88}Co_{0.1}Mn_{0.02}O₂, LiNi_{0.8}Co_{0.15}Al_{0.05}O₂, LiNi_{0.8}Co_{0.1}Mn_{0.2}O₂, or LiNi_{0.88}Co_{0.1}Al_{0.02}O₂.

According to one or more embodiments, the positive electrode active material may include at least one active material selected from Li—Ni—Co—Al (NCA), Li—Ni—Co—Mn (NCM), lithium cobalt oxide (LiCoO₂), lithium manganese oxide (LiMnO₂), lithium nickel oxide (LiNiO₂), and lithium iron phosphate (LiFePO₄).

In one or more embodiments, the negative electrode active material may include at least one selected from a silicon-based compound, a carbon-based material, a composite of a silicon-based compound and a carbon-based compound, and silicon oxide (SiOₓ) (wherein 0<x<2). The silicon-based compound may include silicon particles, silicon alloy particles, and/or the like.

A size of the silicon-based compound may be less than about 200 nm, for example, in a range of about 10 nm to about 150 nm. The term “size” may refer to an average particle diameter when the silicon-based compound is spherical and may refer to an average long axis length when the silicon-based compound is non-spherical.

When the size of the silicon-based compound is within the above range, life characteristics of the silicon-based compound are excellent or suitable, and thus, when the electrolyte according to one or more embodiments is utilized, a lifetime of the lithium secondary battery may be further increased.

The carbon-based material may be crystalline carbon, amorphous carbon, or a mixture thereof. The crystalline carbon may be graphite such as natural graphite or artificial graphite having a non-shaped (e.g., irregularly shaped), plate-like, flake-like, spherical, or fibrous form. The amorphous carbon may be soft carbon (low-temperature fired carbon), hard carbon, mesophase pitch carbide, and/or fired coke.

The composite of the silicon-based compound and the carbon-based compound may be a composite having a structure in which silicon particles are arranged on a carbon-based compound, a composite having a structure in which silicon particles are included on a surface of a carbon-based compound and inside the carbon-based compound, or a composite in which silicon particles are coated with a carbon-based compound and included inside the carbon-based compound. In the composite of the silicon-based compound and the carbon-based compound, the carbon-based compound may be graphite, graphene, graphene oxide, or a combination thereof.

The composite of the silicon-based compound and the carbon-based compound may be an active material obtained by dispersing silicon nanoparticles having an average particle diameter of about 200 nm or less on carbon compound particles and then coating the silicon nanoparticles with carbon or an active material in which silicon (Si) particles are present on graphite and inside graphite. The composite of the silicon-based compound and the carbon-based compound may have an average secondary particle diameter of about 5 μm to about 20 μm. An average particle diameter of the silicon nanoparticles may be about 5 nm or more, for example, about 10 nm or more, for example, about 20 nm or more, for example, about 50 nm or more, or for example, about 70 nm or more. The average particle diameter of the silicon nanoparticles may be about 200 nm or less, about 150 nm or less, about 100 nm or less, about 50 nm or less, about 20 nm or less, or about 10 nm or less. For example, the average particle diameter of the silicon nanoparticles may be in a range of about 100 nm to about 150 nm.

Secondary particles of the composite of the silicon-based compound and the carbon-based compound may have an average diameter of about 5 μm to about 18 μm, for example, about 7 μm to about 15 μm, or for example, about 10 μm to about 13 μm.

As other examples of the composite of the silicon-based compound and the carbon-based compound, a porous silicon composite cluster structure disclosed in Korean Patent Publication No. 10-2018-0031585 and a porous silicon composite cluster structure disclosed in Korean Patent Publication No. 10-2018-0056395 may be utilized. Korean Patent Publication No. 10-2018-0031586 and Korean Patent Publication No. 10-2018-0056395 are incorporated herein by reference in their entireties.

A silicon-carbon-based compound composite according to one or more embodiments may be a porous silicon composite cluster which includes a porous core including a porous silicon composite secondary particle and a shell including second graphene disposed on the core, wherein the porous silicon composite secondary particle may include an aggregate of two or more silicon composite primary particles, and the silicon composite primary particle may include silicon, silicon oxide (SiOₓ) (wherein 0<x<2) disposed on the silicon, and first graphene disposed on the silicon oxide.

A silicon-carbon-based compound composite according to one or more embodiments may be a porous silicon composite cluster structure which includes a porous silicon composite cluster including a porous silicon composite secondary particle and a second carbon flake on at least one surface of the porous silicon composite secondary particle, and a carbon-based coating film including amorphous carbon disposed on the porous silicon composite cluster, wherein the porous silicon composite secondary particle may include an aggregate of two or more silicon composite primary particles, the silicon composite primary particle may include silicon, silicon oxide (SiOₓ) (wherein 0<x<2) on at least one surface of the silicon, and a first carbon flake on at least one surface of the silicon oxide, and the silicon oxide may be present in a state of a film, a matrix, or a combination thereof.

The first carbon flake and the second carbon flake may each be present in a state of a film, a particle, a matrix, or a combination thereof. The first carbon flake and the second carbon flake may each be graphene, graphite, a carbon fiber, graphene oxide, and/or the like.

The composite of the silicon-based compound and the carbon-based compound may be a composite having a structure in which silicon nanoparticles are arranged on a carbon-based compound, a composite having a structure in which silicon particles are included on a surface of a carbon-based compound and inside the carbon-based compound, or a composite in which silicon particles are coated with a carbon-based compound and included inside the carbon-based compound. In the composite of the silicon-based compound and the carbon-based compound, the carbon-based compound may be graphite, graphene, graphene oxide, or a combination thereof.

A shape of the lithium secondary battery is not particularly limited, and the lithium secondary battery may include a lithium ion battery, a lithium ion polymer battery, a lithium sulfur battery, and/or the like.

The lithium secondary battery may be manufactured through the following method.

First, a positive electrode is prepared.

For example, in one or more embodiments, a positive electrode active material composition in which a positive electrode active material, a conductive material, a binder, and a solvent are mixed is prepared. In one or more embodiments, the positive electrode active material composition may be applied directly on a metal current collector to prepare a positive electrode plate. In some embodiments, the positive electrode active material composition may be cast on a separate support, and then the film peeled off of the support may be laminated on a metal current collector to prepare the positive electrode plate. The positive electrode is not limited to forms listed above and may have forms other than the above forms.

As the positive electrode active material, any material, which is utilized as a lithium-containing metal oxide in the art, may be utilized without limitation. For example, at least one composite oxide of lithium and a metal selected from cobalt, manganese, nickel, and a combination thereof may be utilized. A non-limiting example of the positive electrode active material may include a compound represented by any one selected from LiₐA_{1-b}B¹_{b}D¹₂ (wherein 0.90≤a≤1.8 and 0≤b≤0.5), LiₐE_{1-b}B¹_{b}O_{2-c}D¹_{c} (wherein 0.90≤a≤1.8, 0≤b≤0.5, and 0≤c≤0.05), LiE_{2-b}B¹_{b}O_{4-c}D¹_{c} (wherein 0≤b≤0.5 and 0≤c≤0.05), LiₐNi_{1-b-c}Co_{b}B¹_{c}D¹_{α} (wherein 0.90≤a≤1.8, 0≤b≤0.5, 0≤c≤0.05, and 0<α≤2), LiₐNi_{1-b-c}Co_{b}B¹_{c}O_{2-α}F¹_{α} (wherein 0.90≤a≤1.8, 0≤b≤0.5, 0≤c≤0.05, and 0<α<2), LiₐNi_{1-b-c}CO_{b}B¹_{c}O_{2-α}F¹₂ (wherein 0.90≤a≤1.8, 0≤b≤0.5, 0≤c≤0.05, and 0<α<2), LiₐNi_{1-b-c}Mn_{b}B¹_{c}D_{α} (wherein 0.90≤a≤1.8, 0≤b≤0.5, 0≤c≤0.05, and 0<α≤2), LiₐNi_{1-b-c}Mn_{b}B¹_{c}O_{2-α}F¹_{α} (wherein 0.90≤a≤1.8, 0≤b≤0.5, 0≤c≤0.05, and 0<α<2), LiₐNi_{1-b-c}Mn_{b}B¹_{c}O_{2-α}F¹₂ (wherein 0.90≤a≤1.8, 0≤b≤0.5, 0≤c≤0.05, and 0<α<2), LiₐNi_{b}E_{c}G_{d}O₂ (wherein 0.90≤a≤1.8, 0≤b≤0.9, 0≤c≤0.5, and 0.001≤d≤0.1), LiₐNi_{b}Co_{c}Mn_{d}GₑO₂ (wherein 0.90≤a≤1.8, 0≤b≤0.9, 0≤c≤0.5, and 0.001≤e≤0.1), LiₐNiG_{b}O₂ (wherein 0.90≤a≤1.8 and 0.001≤b≤0.1), LiₐCoG_{b}O₂ (wherein 0.90≤a≤1.8 and 0.001≤b≤0.1), LiₐMnG_{b}O₂ (wherein 0.90≤a≤1.8 and 0.001≤b≤0.1), LiₐMn₂G_{b}O₄ (wherein 0.90≤a≤1.8 and 0.001≤b≤0.1), QO₂, QS₂, LiQS₂, V₂O₅, LiV₂O₅, LiIO₂, LiNiVO₄, Li_{(3-f)}J₂(PO₄)₃ (wherein 0≤f≤2), Li_{(3-f)}Fe₂(PO₄)₃ (wherein 0≤f≤2), and LiFePO₄.

In the formulas above, A may be nickel (Ni), cobalt (Co), manganese (Mn), or a combination thereof, B¹ may be aluminum (Al), Ni, Co, Mn, chromium (Cr), iron (Fe), magnesium (Mg), strontium (Sr), vanadium (V), a rare earth element, or a combination thereof, D¹ may be oxygen (O), fluorine (F), sulfur (S), phosphorus (P), or a combination thereof, E may be Co, Mn, or a combination thereof, F¹ may be F, S, P, or a combination thereof, G may be Al, Cr, Mn, Fe, Mg, lanthanum (La), cerium (Ce), Sr, V, or a combination thereof, Q may be Ti, Mo, Mn, or a combination thereof, I may be Cr, V, Fe, scandium (Sc), yttrium (Y), or a combination thereof, and J may be V, Cr, Mn, Co, Ni, copper (Cu), or a combination thereof.

For example, in some embodiments, LiCoO₂, LiMnₓO₂ₓ (wherein x=1 or 2), LiNi₁₋ₓMnₓO₂ₓ (0<x<1), LiNi_{1-x-y}CoₓMn_{y}O₂ (wherein 0≤x≤0.5 or 0≤y≤0.5), LiFePO₄, and/or the like may be utilized.

In some embodiments, a compound having a coating layer on a surface of the compound may be utilized, or a mixture of the compound and a compound having a coating layer may be utilized. The coating layer may include a coating element compound of an oxide or hydroxide of a coating element, an oxyhydroxide of a coating element, an oxycarbonate of a coating element, or a hydroxycarbonate of a coating element. A compound constituting the coating layer may be amorphous or crystalline. The coating element included in the coating layer may include Mg, Al, Co, K, Na, Ca, Si, Ti, V, Sn, Ge, Ga, B, As, Zr, or a mixture thereof. In a process of forming the coating layer, any coating method may be utilized as long as the compound may be coated with such elements through a method (for example, a spray coating method or a dipping method) that does not adversely affect physical properties of the positive electrode active material. Because the coating method is well understood by those who work in the related field, a detailed description thereof will not be provided.

In one or more embodiments, the conductive material may include carbon black, graphite fine particles, and/or the like, but embodiments of the present disclosure are not limited thereto. Any material utilized as a conductive material in the art may be utilized.

In one or more embodiments, the binder may include at least one selected from vinylidene a fluoride/hexafluoropropylene copolymer, polyvinylidene fluoride (PVDF), polyacrylonitrile, polymethyl methacrylate, polytetrafluoroethylene, a mixture thereof, and a styrene butadiene rubber-based polymer, but embodiments of the present disclosure are not limited thereto. Any material utilized as a binder in the art may be utilized.

In one or more embodiments, the solvent may include N-methyl pyrrolidone, acetone, and/or water, but embodiments of the present disclosure are not limited thereto. Any solvent utilized in the art may be utilized.

Contents (e.g., amounts) of the positive electrode active material, the conductive material, the binder, and the solvent are at levels that are commonly utilized in a lithium battery. In some embodiments, one or more selected from the conductive material, the binder, and the solvent may not be provided according to the utilization and configuration of a lithium battery.

Next, a negative electrode is prepared.

For example, in one or more embodiments, a negative electrode active material composition is prepared by mixing a negative electrode active material, a conductive material, a binder, and a solvent. In one or more embodiments, the negative electrode active material composition may be applied directly on a metal current collector and dried to prepare a negative electrode plate. In some embodiments, the negative electrode active material composition may be cast on a separate support, and then a film peeled off of the support may be laminated on a metal current collector to prepare the negative electrode plate.

As the negative electrode active material, any material, which is utilized as a negative electrode active material for a lithium battery in the art, may be utilized. For example, in one or more embodiments, the negative electrode active material may include at least one selected from a lithium metal, a metal capable of forming an alloy with lithium, a transition metal oxide, a non-transition metal oxide, and a carbon-based material.

For example, in some embodiments, the metal capable of forming an alloy with lithium may be silicon (Si), tin (Sn), aluminum (Al), germanium (Ge), lead (Pb), bismuth (Bi), antimony (Sb), a Si—Y alloy (wherein Y is an alkali metal, an alkaline earth metal, a Group 13 element, a Group 14 element, a transition metal, a rare earth element, or a combination thereof and is not Si), or a Sn—Y alloy (wherein Y is an alkali metal, an alkaline earth metal, a Group 13 element, a Group 14 element, a transition metal, a rare earth element, or a combination thereof and is not Sn).The element Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), thallium (TI), germanium (Ge), phosphorus (P), arsenic (As), antimony (Sb), bismuth (Bi), sulfur (S), selenium (Se), tellurium (Te), polonium (Po), or a combination thereof.

For example, the transition metal oxide may be lithium titanium oxide, vanadium oxide, or lithium vanadium oxide.

For example, the non-transition metal oxide may be SnO₂, SiOₓ (wherein 0<x<2), and/or the like.

In one or more embodiments, the carbon-based material may be crystalline carbon, amorphous carbon, or a mixture thereof. The crystalline carbon may be graphite such as non-shaped (e.g., irregularly shaped), plate-shaped, flake-shaped, spherical, or fibrous natural graphite or artificial graphite. The amorphous carbon may be soft carbon (low-temperature fired carbon) or hard carbon, mesophase pitch carbide, fired coke, and/or the like.

In one or more embodiments, the conductive material and the binder in the negative electrode active material composition may be the same as those in the above-described positive electrode active material composition.

Contents (e.g., amounts) of the negative electrode active material, the conductive material, the binder, and the solvent are at levels that are utilized in a lithium battery. In some embodiments, one or more selected from the conductive material, the binder, and the solvent may not be provided according to the utilization and configuration of a lithium battery.

Next, a separator to be inserted between the positive electrode and the negative electrode is prepared.

As the separator, any separator utilized in a lithium battery may be utilized. A separator having low resistance to the movement of ions in an electrolyte and an excellent or suitable electrolyte impregnation ability may be utilized. For example, in one or more embodiments, the separator may include at least one selected from a glass fiber, polyester, Teflon, polyethylene, polypropylene, polytetrafluoroethylene (PTFE), and a combination thereof and may be in the form of a nonwoven fabric or a woven fabric. For example, in some embodiments, a windable separator including polyethylene, polypropylene, and/or the like may be utilized in a lithium ion battery, and a separator having an excellent or suitable electrolyte impregnation ability may be utilized in a lithium ion polymer battery. For example, in one or more embodiments, the separator may be prepared according to the following method.

A polymer resin, a filler, and a solvent are mixed to prepare a separator composition. In one or more embodiments, the separator composition may be applied directly on an electrode and dried to form the separator. In some embodiments, the separator composition may be cast on a support, and then a separator film peeled off of the support may be laminated on an electrode to form the separator.

The polymer resin utilized for preparing the separator is not particularly limited, and any material utilized in a binding material of an electrode plate may be utilized. For example, in some embodiments, the polymer resin may include a vinylidene fluoride/hexafluoropropylene copolymer, PVDF, polyacrylonitrile, polymethyl methacrylate, or a mixture thereof.

Next, the above-described electrolyte is prepared.

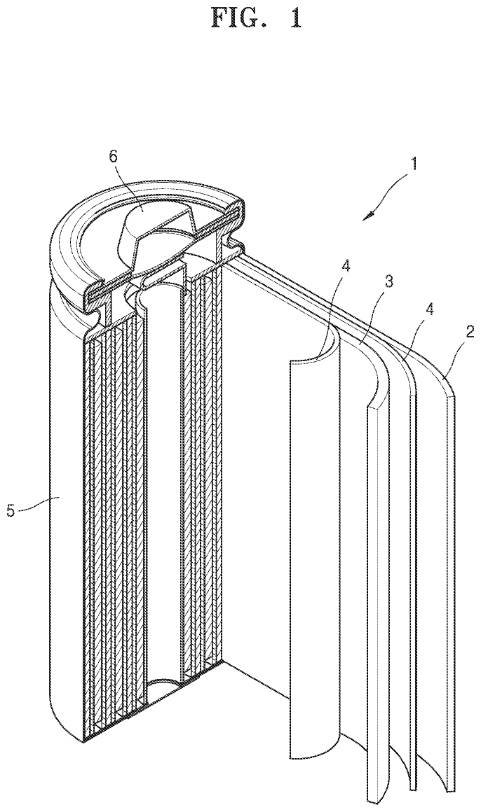

As shown in FIG. 1, a lithium battery 1 may include a positive electrode 3, a negative electrode 2, and a separator 4. The positive electrode 3, the negative electrode 2, and the separator 4 may be wound or folded and accommodated in a battery case 5. Subsequently, an electrolyte may be injected into the battery case 5, and the battery case 5 may be sealed with a cap assembly 6 to complete the lithium battery 1. The battery case 5 may have a cylindrical shape, a prismatic shape, a thin film shape, and/or the like. For example, in some embodiments, the lithium battery 1 may be a large-sized thin film battery. In one or more embodiments, the lithium battery 1 may be a lithium ion battery.

In one or more embodiments, the separator 4 may be disposed between the positive electrode 3 and the negative electrode 2 to form a battery structure. The battery structure may be stacked in a bi-cell structure and then impregnated in an organic electrolyte, and an obtained battery structure may be accommodated in a pouch and sealed, thereby completing a lithium ion polymer battery.

In some embodiments, a plurality of battery structures may be stacked to form a battery pack, and such a battery pack may be utilized in all devices requiring high capacity and high power. For example, the battery pack may be utilized in a laptop computer, a smartphone, an electric vehicle, and/or the like.

In a lithium secondary battery according to one or more embodiments, an increase in direct current internal resistance (DCIR) may be considerably reduced as compared with a lithium secondary battery adopting general nickel-rich lithium-nickel composite oxide as a positive electrode active material, thereby exhibiting excellent or suitable battery characteristics.

An operating voltage of a lithium secondary battery to which the positive electrode, the negative electrode, and the electrolyte are applied may have, for example, a lower limit of about 2.5 V to about 2.8 V and an upper limit of about 4.1 V or more, and the upper limit may be, for example, in a range of about 4.1 V to about 4.45 V.

In some embodiments, the lithium secondary battery may be utilized in, for example, a power tool that moves by receiving power from an electric motor, an electric motor vehicle such as an electric vehicle (EV), a hybrid electric vehicle (HEV), or a plug-in hybrid electric vehicle (PHEV), an electric two-wheeled vehicle such as an electric bike (E-bike) or an electric scooter (E-scooter), an electric golf cart, a power storage system, and/or the like, but embodiments of the present disclosure are not limited thereto.

As utilized herein, the term “alkyl group” refers to a branched or unbranched aliphatic hydrocarbon group. In one or more embodiments, the alkyl group may be substituted or unsubstituted. Examples of the alkyl group may include a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, a cycloheptyl group, and/or the like, but embodiments of the present disclosure are not limited thereto. In some embodiments, each of the examples of the alkyl group may be optionally substituted. In some embodiments, the alkyl group may have 1 to 6 carbon atoms. For example, a C1-C6 alkyl group may include a methyl group, an ethyl group, a propyl group, an isopropyl group, a butyl group, an isobutyl group, a sec-butyl group, a pentyl group, a 3-pentyl group, a hexyl group, and/or the like, but embodiments of the present disclosure are not limited thereto.

In some embodiments, at least one hydrogen of alkyl may be substituted with a halogen, a C1-C20 alkyl group substituted with a halogen (for example, CCF₃, CHCF₂, CH₂F, or CCl₃), a C1-C20 alkoxy group, a C2-C20 alkoxyalkyl group, a hydroxyl group, a nitro group, a CN group, an amino group, an amidino group, hydrazine, hydrazone, a carboxyl group or a salt thereof, a sulfonyl group, a sulfamoyl group, a sulfonic acid or a salt thereof, a phosphoric acid or a salt thereof, a C1-C20 alkyl group, a C2-C20 alkenyl group, a C2-C20 alkynyl group, a C1-C20 heteroalkyl group, a C6-C20 aryl group, a C7-C20 arylalkyl group, a C6-C20 heteroaryl group, a C7-C20 heteroarylalkyl group, a C6-C20 heteroaryloxy group, or a C6-C20 heteroaryloxyalkyl group.

As utilized herein, the term “alkenyl group” may refer to a C2 to C20 hydrocarbon group having at least one carbon-carbon double bond. Examples of the alkenyl group may include an ethenyl group, a 1-propenyl group, a 2-propenyl group, a 2-methyl-1-propenyl group, a 1-butenyl group, a 2-butenyl group, a cyclopropenyl group, cyclopentenyl, cyclohexenyl, cycloheptenyl, and/or the like, but embodiments of the present disclosure are not limited thereto. In some embodiments, the alkenyl group may be substituted or unsubstituted. In some embodiments, the alkenyl group may have 2 to 40 carbon atoms.

As utilized herein, the term “alkynyl group” may refer to a C2 to C20 hydrocarbon group having at least one carbon-carbon triple bond. Examples of the alkynyl group may include an ethynyl group, a 1-propynyl group, a 1-butynyl group, a 2-butynyl group, and/or the like, but embodiments of the present disclosure are not limited thereto. In some embodiments, the alkynyl group may be substituted or unsubstituted. In some embodiments, the alkynyl group may have 2 to 40 carbon atoms.

In the present disclosure, a substituted group is derived from an unsubstituted parent group in which at least one hydrogen atom is substituted with another atom or a functional group. Unless otherwise indicated, when a functional group is deemed to be “substituted,” it is meant that the functional group is substituted with at least one substituent independently selected from a C1-C20 group, a C2-C20 alkenyl group, a C2-C20 alkynyl group, a C1-C20 alkoxy group, a halogen, a CN group, a hydroxyl group, and a nitro group. When a functional group is described as being “optionally substituted,” the functional group may be substituted with at least one selected from the above-described substituents.

The term “halogen” may include fluorine, bromine, chlorine, iodine, and/or the like.

The term “alkoxy” may refer to “alkyl-O—”, and alkyl may be defined above. Non-limiting examples of an alkoxy group may include a methoxy group, an ethoxy group, a 2-propoxy group, a butoxy group, a t-butoxy group, a pentyloxy group, a hexyloxy group, and/or the like. At least one hydrogen of the alkoxy may be substituted with the same substituent as the above-described alkyl group.

The term “heteroaryl” may refer to a monocyclic or bicyclic organic group including at least one heteroatom selected from N, O, P, and S, wherein the remaining ring atoms are all carbon. A heteroaryl group may include, for example, one to five heteroatoms, and in some embodiments, may include a five- to ten-membered ring. S or N may be oxidized to have one or more suitable oxidation states.

Non-limiting examples of the heteroaryl may include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isooxazol-3-yl, isooxazol-4-yl, isooxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2-yl, pyrazin-4-yl, pyrazin-5-yl, 2-pyrimidin-2-yl, 4-pyrimidin-2-yl, and/or 5-pyrimidin-2-yl.

The term “heteroaryl” may include an embodiment in which a heteroaromatic ring is selectively fused to at least one of an aryl group, a cycloaliphatic group, or a heterocyclic group.

The term “carbon ring” may refer to a saturated or partially unsaturated non-aromatic monocyclic, bicyclic, or tricyclic hydrocarbon group.

Non-limiting examples of monocyclic hydrocarbon may include cyclopentyl, cyclopentenyl, cyclohexyl, cyclohexenyl, and/or the like.

Non-limiting examples of bicyclic hydrocarbon may include bornyl, decahydronaphthyl, bicyclo[2.1.1]hexyl, bicyclo[2.2.1]heptyl, bicyclo[2.2.1]heptenyl, and/or bicyclo[2.2.2]octyl.

Non-limiting examples of tricyclic hydrocarbon may include adamantly and/or the like.

In some embodiments, at least one hydrogen in the carbon ring may be substituted with a substituent similar to the above-described alkyl group.

Hereinafter, the present disclosure will be described in more detail through the following Examples and Comparative Examples. However, the following Examples and Comparative Examples are merely presented to exemplify the present disclosure, and the scope of the present disclosure is not limited thereto.

### EXAMPLES

### Preparation of Electrolyte

### Comparative Example 1

1.15 M LiPF₆ was added to a mixed solvent of EC, EMC, and DMC having a volume ratio of 20:40:40 to prepare an electrolyte.

### Comparative Example 2

With respect to 100 wt % of the total weight of the electrolyte of Comparative Example 1, 1 wt % of VC as an additive was added to the electrolyte.

### Example 1

With respect to 100 wt % of the total weight of the electrolyte of Comparative Example 1, 1 wt % of Compound A as an additive was added to the electrolyte to prepare an electrolyte.

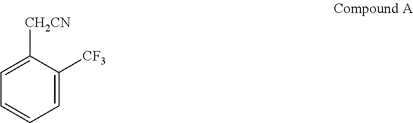

### Example 2

With respect to 100 wt % of the total weight of the electrolyte of Comparative Example 1, 1 wt % of Compound B as an additive was added to the electrolyte to prepare an electrolyte.

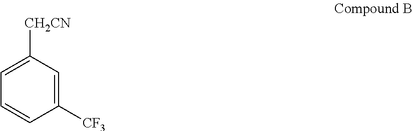

### Example 3

An electrolyte was prepared in substantially the same manner as in Comparative Example 2, except that, with respect to 100 wt % of the total weight of the electrolyte of Comparative Example 2, 3 wt % of Compound A as an additive was further added to the electrolyte.

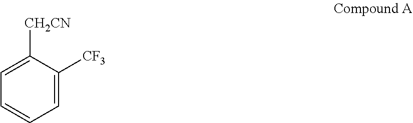

### Examples 4 to 8

Electrolytes were prepared in substantially the same manner as in Example 3, except that Compound B, Compound C, Compound D, Compound E, and Compound F were utilized as additives instead of Compound A, respectively.

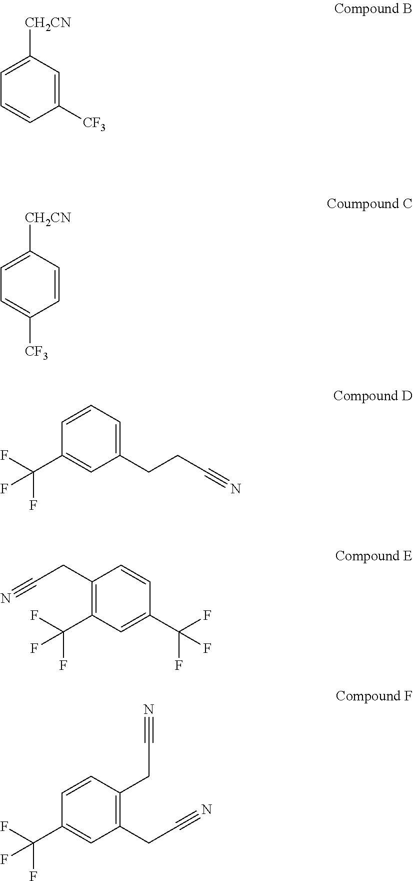

### Examples 9 and 10

Electrolytes were each prepared in substantially the same manner as in Example 4, except that contents of Compound B were respectively changed into 5 wt % and 7 wt % with respect to 100 wt % of the total weight of the electrolyte.

### Comparative Example 3

An electrolyte was prepared in substantially the same manner as in Comparative Example 2, except that Compound J was utilized as an additive in the electrolyte of Comparative Example 2, and a content (e.g., amount) of the additive was 3 wt % with respect to 100 wt % of the total weight of the electrolyte.

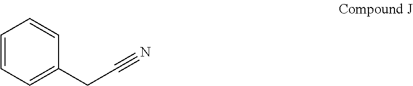

### Comparative Example 4

An electrolyte was prepared in substantially the same manner as in Comparative Example 2, except that Compound K was utilized as an additive in the electrolyte of Comparative Example 2, and a content (e.g., amount) of the additive was 3 wt % with respect to 100 wt % of the total weight of the electrolyte.

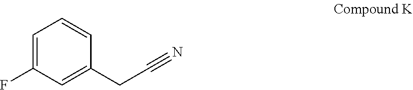

### Manufacturing of Lithium Secondary Battery (Pouch Cell)

### Manufacturing Example 1

98 wt % of graphite particles, 1 wt % of carboxymethyl cellulose (CMC), and 1 wt % of a styrene-butadiene rubber (SBR) aqueous dispersion binder were mixed, put into distilled water, and then stirred for 60 minutes utilizing a mechanical stirrer to prepare slurry of a negative (electrode) active material. The slurry was applied to a thickness of about 60 μm on a copper current collector with a thickness of 10 μm utilizing a doctor blade, dried in a hot air dryer at a temperature of 100° C. for 0.5 hours, dried once more for 4 hours under conditions of vacuum and a temperature of 120° C., and roll-pressed to prepare a negative electrode. A mixture density (E/D) of the negative electrode was 1.55 g/cc, and a loading level (L/L) thereof was 14.36 mg/cm².

Separately, a positive electrode was prepared according to the following procedure.

94 wt % of LiNi_{0.6}Co_{0.2}Mn_{0.2}O₂ (NCM 622 manufactured by Münster Electrochemical Energy Technology), 3.0 wt % of a conductive material (Denka black), and 3.0 wt % of a binder (PVDF) were mixed, put into an N-methyl-2-pyrrolidone solvent, and then stirred for 30 minutes utilizing a mechanical stirrer to prepare slurry of a positive electrode active material. The slurry was applied to a thickness of about 60 μm on an aluminum current collector with a thickness of 20 μm utilizing a doctor blade, dried in a hot air dryer at a temperature of 100° C. for 0.5 hours, dried once more for 4 hours under conditions of vacuum and a temperature of 120° C., and roll-pressed to prepare the positive electrode. A mixture density (E/D) of the positive electrode was 3.15 g/cc, and a loading level (L/L) thereof was 27.05 mg/cm².

A lithium secondary battery (pouch cell having about 40 mAh) was manufactured utilizing a polyethylene separator (thickness of 16 μm) as a separator and utilizing the electrolyte of Example 3 as an electrolyte.

### Manufacturing Examples 2 to 7

Lithium secondary batteries (pouch cells) were each manufactured in substantially the same manner as in Manufacturing Example 1, except that the electrolytes prepared in Examples 4 to 9 were respectively utilized instead of the electrolyte prepared in Example 3.

### Manufacturing Example 8

A lithium secondary battery (pouch cell) was manufactured in substantially the same manner as in Manufacturing Example 1, except that the electrolyte prepared in Example 10 was utilized instead of the electrolyte prepared in Example 3.

### Comparative Manufacturing Examples 1 to 3

Lithium secondary batteries (pouch cells) were each manufactured in substantially the same manner as in Manufacturing Example 1, except that the electrolytes prepared in Comparative Examples 2 to 4 were respectively utilized instead of the electrolyte prepared in Example 3.

### Evaluation Example 1: Linear Sweep Voltammetry (Linear Test)

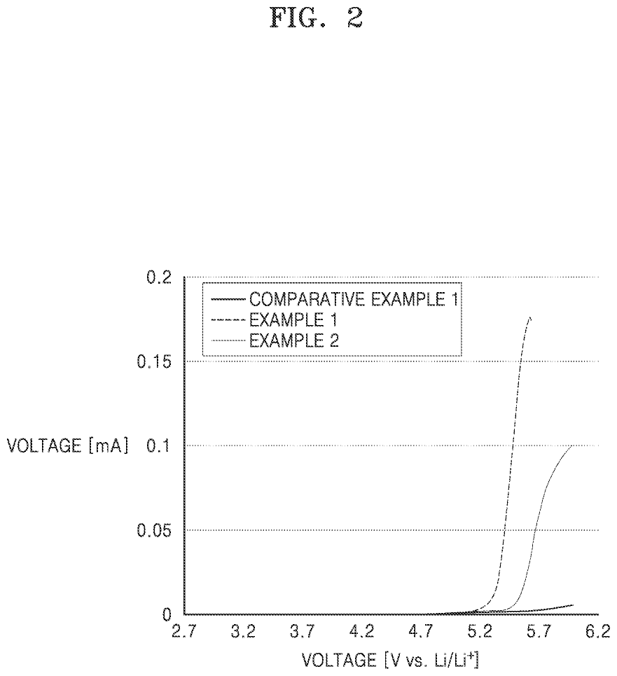

A three-electrode beaker cell was constructed utilizing each of the electrolytes of Examples 1 and 2 and Comparative Example 1, and then a linear sweep voltammetry test was performed to evaluate an oxidation behavior of the electrolyte at a working electrode. Results thereof are shown in FIG. 2.

A glassy carbon electrode was utilized as the working electrode, and a lithium metal was utilized as each of a counter electrode and a reference electrode to assemble the three-electrode beaker cell, and the three-electrode beaker cell was left for 1 hour to then perform measurement. Under a measurement condition of room temperature, a voltage was applied at a rate of 1 mV/sec up to an open circuit voltage (OCV) of 6 V (vs. Li/Li⁺) to perform scanning.

Referring to FIG. 2, it was confirmed that the electrolyte of Example 1 and the electrolyte of Example 2 were oxidized near about 5.2 V and 5.4 V, respectively. As compared with the electrolyte prepared in Comparative Example 1, it may be confirmed that oxidation may proceed rapidly, and an additive may be decomposed in an overcharge environment (high voltage) to suppress or reduce a voltage rise of a battery and contribute to an improvement in the safety of a cell.

### Evaluation Example 2: Overcharge Characteristics

The lithium secondary batteries manufactured according to Manufacturing Examples 1 to 7 and Comparative Manufacturing Examples 1 to 3 were each subjected to a formation operation, and an overcharge test was prepared for the lithium secondary batteries subjected to the formation operation in a discharged state.

After the formation operation, the overcharge test was performed utilizing Biologics, and an amount of gas after overcharging was measured utilizing the Archimedes' principle.

Overcharge protocol: after discharging at 0.2 C and 2.5 V, overcharging was performed under c/o conditions of 1 C, 6 V, and 5 hours. After the overcharging was performed, a cell was left for about three hours to then perform a formation operation according to the Archimedes' principle, and then an amount of gas caused by the overcharging after the overcharging was confirmed through a difference in volume of the amount of gas. Results thereof are shown in Table 1.

TABLE 1

| | Composition | Amount of gas due |
|---|---|---|
| TEST No. | of additive | to overcharging |
| Comparative | 1 wt % of VC | 9.9 mL |
| Manufacturing | | |
| Example 1 | | |
| Manufacturing | 3 wt % of | 6.5 mL |
| Example 1 | Compound A | |
| Manufacturing | 3 wt % of | 4.1 mL |
| Example 2 | Compound B | |
| Manufacturing | 3 wt % of | 5.8 mL |
| Example 3 | Compound C | |
| Manufacturing | 3 wt % of | 3.3 mL |
| Example 4 | Compound D | |
| Manufacturing | 3 wt % of | 6.4 mL |
| Example 5 | Compound E | |
| Manufacturing | 3 wt % of | 5.7 mL |
| Example 6 | Compound F | |
| Manufacturing | 5 wt % of | 3.0 mL |
| Example 7 | Compound B | |
| Comparative | 3 wt % of | 9.5 mL |
| Manufacturing | Compound J | |
| Example 2 | | |
| Comparative | 3 wt % of | 9.7 mL |
| Manufacturing | Compound K | |
| Example 3 | | |

As shown in Table 1, in all of the lithium secondary batteries of Manufacturing Examples 1 to 7 utilizing the electrolytes of Examples 3 to 9, it was confirmed that an amount of gas generated in an overcharged state could be reduced as compared with the lithium secondary batteries of Comparative Manufacturing Examples 1 to 3 utilizing the electrolytes of Comparative Examples 2 to 4. Thus, it was seen that, when the electrolytes of Examples 3 to 9 including Compounds A to F were utilized, all of the electrolytes could effectively protect the positive electrode and reduce an amount of generated gas to contribute to an improvement in safety even in an overcharged state.

### Evaluation Example 3: High-Temperature (45° C.) Charge/Discharge Characteristics

The lithium secondary batteries manufactured according to manufacturing Examples 1 to 8 and Comparative manufacturing Examples 1 to 3 were each subjected to a formation operation at a temperature of 45° C., the lithium secondary batteries subjected to the formation operation were charged at a constant current rate of 1.5 C until a voltage reached 4.2 V (vs. Li), and then, in a constant voltage mode, while 4.2 V was maintained, the charging was cut off at a current rate of 0.05 C. Subsequently, the lithium secondary batteries were discharged at a constant current rate of 0.5 C until the voltage reached 2.5 V (vs. Li) during discharging. Such a charging/discharging cycle was repeated 300 times. The lithium batteries were rested for 10 minutes after each charging/discharging cycle. Results thereof are shown in Table 2. A capacity retention rate at a 300th cycle is defined by Equation 1.

capacity retention rate=[discharge capacity at 300^{th} cycle/discharge capacity at first cycle]×100 Equation 1

TABLE 2

| | | High-temperature |
|---|---|---|
| | Composition | (45° C.) capacity |
| TEST No. | of additive | retention rate (%) |
| Comparative | 1 wt % of VC | 75 |
| Manufacturing | | |
| Example 1 | | |
| Manufacturing | 3 wt % of | 89 |
| Example 1 | Compound A | |
| Manufacturing | 3 wt % of | 92 |
| Example 2 | Compound B | |
| Manufacturing | 3 wt % of | 85 |
| Example 3 | Compound C | |
| Manufacturing | 3 wt % of | 86 |
| Example 4 | Compound D | |
| Manufacturing | 3 wt % of | 81 |
| Example 5 | Compound E | |
| Manufacturing | 3 wt % of | 84 |
| Example 6 | Compound F | |
| Manufacturing | 5 wt % of | 93 |
| Example 7 | Compound B | |
| Manufacturing | 7 wt % of | 91 |
| Example 8 | Compound B | |
| Comparative | 3 wt % of | 77 |
| Manufacturing | Compound J | |
| Example 2 | | |
| Comparative | 3 wt % of | 75 |
| Manufacturing | Compound K | |
| Example 3 | | |

As shown in Table 2, it was seen that, in the lithium secondary batteries of Manufacturing Examples 1 to 8 utilizing the electrolytes of Examples 3 to 10, a high-temperature lifetime (e.g., high-temperature capacity retention rate) was increased as compared with Comparative Manufacturing Examples 1 to 3. Among the lithium secondary batteries, in the lithium secondary battery of Manufacturing Example 2 which included the electrolyte of Example 4 utilizing Compound B as an additive, a high-temperature lifetime (e.g., high-temperature capacity retention rate) increased the most.

While one or more embodiments of the present disclosure have been described with reference to the drawings and Examples, the description merely illustrates, and it will be understood by those of ordinary skill in the art that one or more suitable modifications and other equivalent embodiments are possible therefrom. Therefore, the protection scope of the disclosure should be defined by the appended claims and equivalents thereof.

The electrolyte for a lithium secondary battery according to one or more embodiments may form a film on a positive electrode under an overcharge and overvoltage environment to protect the positive electrode and suppress or reduce a voltage rise of a battery, thereby suppressing electrolyte decomposition. Therefore, when such an electrolyte is adopted, a positive electrode may be protected in an overcharge environment, thereby providing a lithium secondary battery having improved safety and also having improved life characteristics at a high temperature.

In the present disclosure, when particles are spherical, “size” or “particle diameter” indicates a diameter or an diameter, and when the particles are non-spherical, the “size” or “particle diameter” indicates a major axis length or an average major axis length. The diameter (or size) of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D50. D50 refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

As utilized herein, the terms “substantially,” “about,” or similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the drawings, it will be understood by those of ordinary skill in the art that one or more suitable changes in form and details may be made therein without departing from the spirit and scope of the disclosure as defined by the following claims and equivalents thereof.

What is claimed is:

1. An electrolyte for a lithium secondary battery, the electrolyte comprising:
a lithium salt;
an organic solvent; and
an additive represented by Formula 1: 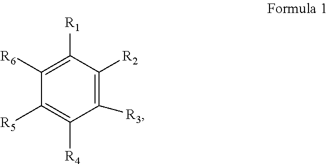
wherein, in Formula 1, at least one selected from among R₁ to R₆ is a C1-C5 alkyl group comprising a cyano (CN) group,
one or two selected from among R₁ to R₆ are each a fluorinated C1-C5 alkyl group, and
the remainder of R₁ to R₆ are each independently hydrogen, a substituted or unsubstituted C1-C5 alkyl group, a substituted or unsubstituted C2-C10 alkenyl group, a substituted or unsubstituted C2-C10 alkynyl group, a substituted or unsubstituted C3-C20 cycloalkyl group, a substituted or unsubstituted C6-C50 aryl group, a substituted or unsubstituted C7-C50 alkylaryl group, or a substituted or unsubstituted C6-C50 heteroaryl group.

2. The electrolyte of claim 1, wherein, in Formula 1, one or two selected from among R₁ to R₆ are each a C1-C5 alkyl group comprising a CN group.

3. The electrolyte of claim 1, wherein the additive is at least one selected from compounds represented by Formulas 1-1 to 1-4: 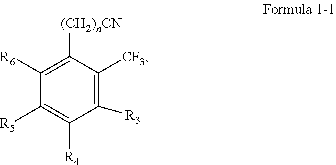
wherein, in Formula 1-1, R₃ to R₆ are each independently hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n is an integer from 1 to 4, 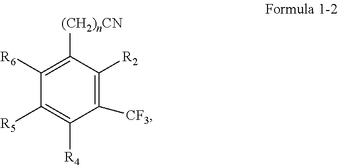
wherein, in Formula 1-2, R₂ and R₄ to R₆ are each independently hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n is an integer from 1 to 4, 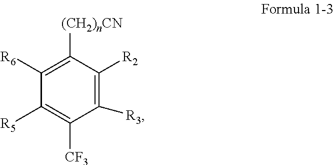
wherein, in Formula 1-3, R₂, R₃, R₅, and R₆ are each independently hydrogen, a C1-C5 alkyl group, a C2-C10 alkenyl group, a C2-C10 alkynyl group, a C3-C20 cycloalkyl group, a C6-C50 aryl group, a C7 -C50 alkylaryl group, or a C6-C50 heteroaryl group, and n is an integer from 1 to 4, and 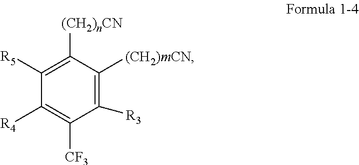
wherein, in Formula 1-4, R₃, R₄, and R₅ are each independently hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n and m are each independently an integer of 1 to 4.

4. The electrolyte of claim 1, wherein the additive represented by Formula 1 is at least one selected from Compounds A to I:

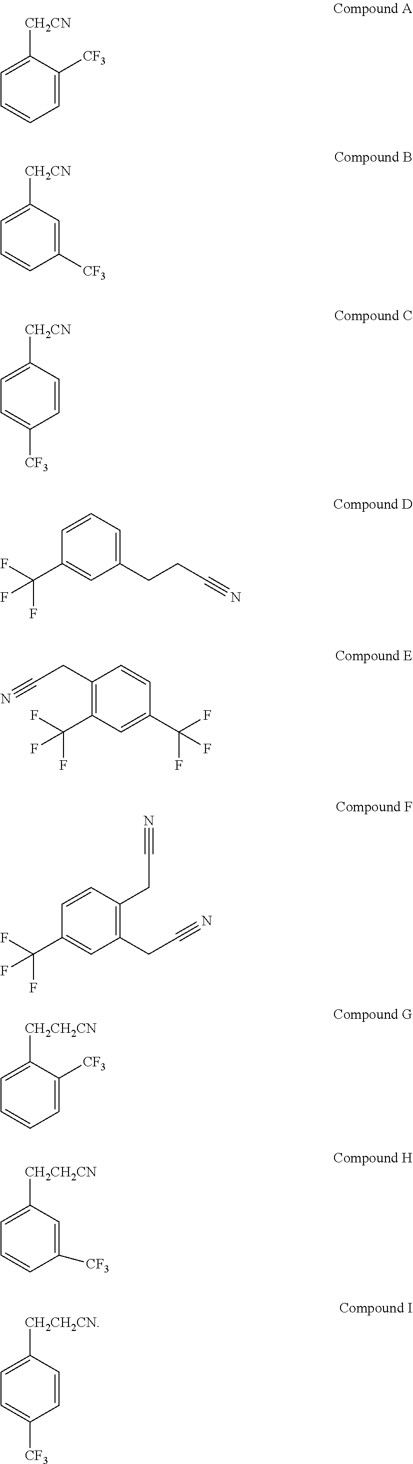

5. The electrolyte of claim 1, wherein an amount of the additive is in a range of about 0.1 wt % to about 10 wt % with respect to a total weight of the electrolyte.

6. The electrolyte of claim 1, wherein an amount of the additive is in a range of about 1 wt % to about 7 wt % with respect to a total weight of the electrolyte.

7. The electrolyte of claim 1, wherein a concentration of the lithium salt is in a range of about 0.1 M to about 5.0 M.

8. The electrolyte of claim 1, wherein the lithium salt comprises at least one selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), and compounds represented by Formulas 2 to 5:

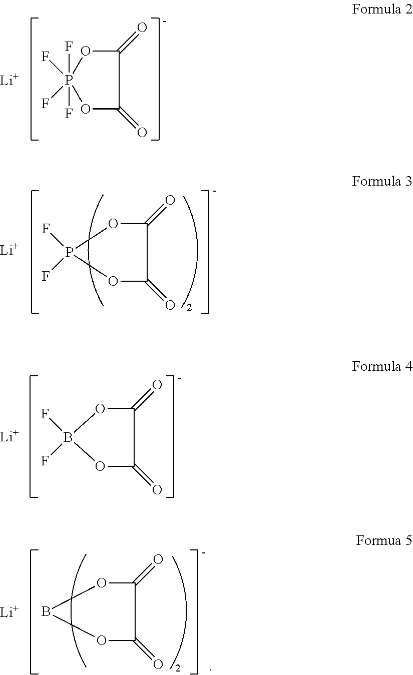

9. The electrolyte of claim 1, wherein the organic solvent comprises at least one selected from ethyl methyl carbonate, methyl propyl carbonate, ethyl propyl carbonate, dimethyl carbonate, diethyl carbonate, dipropyl carbonate, propylene carbonate, ethylene carbonate, fluoroethylene carbonate, vinylene carbonate, vinylethylene carbonate, butylene carbonate, ethyl propionate, ethyl butyrate, dimethyl sulfoxide, dimethylformamide, dimethylacetamide, gamma-valerolactone, gamma-butyrolactone, and tetrahydrofuran.

10. A lithium secondary battery, comprising:
a positive electrode comprising a positive electrode active material;
a negative electrode comprising a negative electrode active material; and
the electrolyte of claim 1 between the positive electrode and the negative electrode.

11. The lithium secondary battery of claim 10, wherein, in Formula 1, one or two selected from among R₁ to R₆ are each a C1-C5 alkyl group comprising a CN group.

12. The lithium secondary battery of claim 10, wherein the additive is at least one selected from compounds represented by Formulas 1-1 to 1-4: 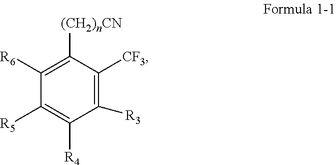
wherein, in Formula 1-1, R₃ to R₆ are each independently hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n is an integer from 1 to 4, 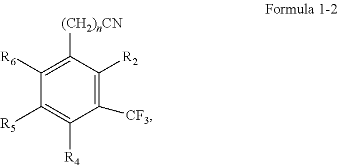
wherein, in Formula 1-2, R₂ and R₄ to R₆ are each independently hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n is an integer from 1 to 4, 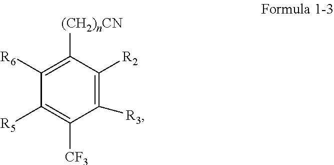
wherein, in Formula 1-3, R₂, R₃, R₅, and R₆ are each independently hydrogen, a C1-C5 alkyl group, a C2-C10 alkenyl group, a C2-C10 alkynyl group, a C2-C20 cycloalkyl group, a C6-C50 aryl group, a C7 -C50 alkylaryl group, or a C6-C50 heteroaryl group, and n is an integer from 1 to 4, and 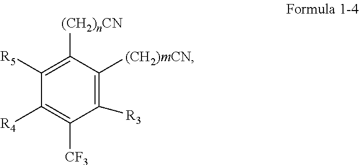
wherein, in Formula 1-4, R₃, R₄, and R₅ are each independently hydrogen, a C1-C5 alkyl group, a C2-C10 alkenyl group, a C2-C10 alkynyl group, a C3-C20 cycloalkyl group, a C6-C50 aryl group, a C7-C50 alkylaryl group, or a C6-C50 heteroaryl group, and n and m are each independently an integer of 1 to 4.

13. The lithium secondary battery of claim 10, wherein the additive represented by Formula 1 is at least one selected from Compounds A to I:

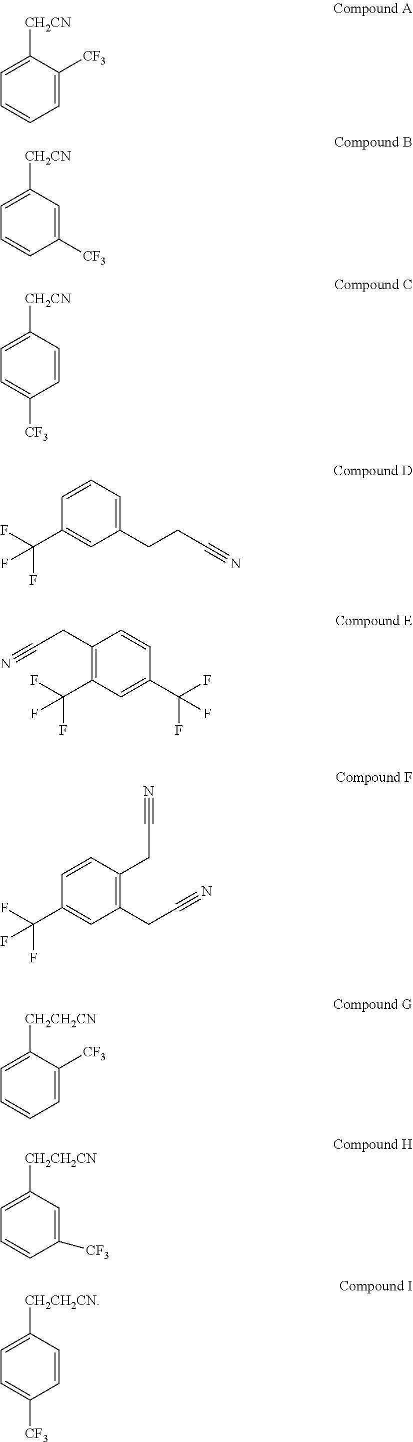

14. The lithium secondary battery of claim 10, wherein an amount of the additive is in a range of about 0.1 wt % to about 10 wt % with respect to a total weight of the electrolyte.

15. The lithium secondary battery of claim 10, wherein an amount of the additive is in a range of about 1 wt % to about 7 wt % with respect to a total weight of the electrolyte.

16. The lithium secondary battery of claim 10, wherein a concentration of the lithium salt is in a range of about 0.1 M to about 5.0 M.

17. The lithium secondary battery of claim 10, wherein the lithium salt comprises at least one selected from LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein 2≤x≤20 and 2≤y≤20), LiCl, LiI, lithium bis(oxalato)borate (LiBOB), and compounds represented by Formulas 2 to 5:

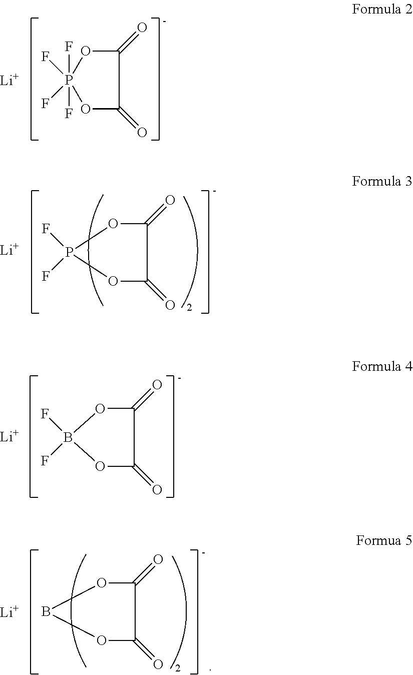

18. The lithium secondary battery of claim 10, wherein the organic solvent comprises at least one selected from ethyl methyl carbonate, methyl propyl carbonate, ethyl propyl carbonate, dimethyl carbonate, diethyl carbonate, dipropyl carbonate, propylene carbonate, ethylene carbonate, fluoroethylene carbonate, vinylene carbonate, vinylethylene carbonate, butylene carbonate, ethyl propionate, ethyl butyrate, dimethyl sulfoxide, dimethylformamide, dimethylacetamide, gamma-valerolactone, gamma-butyrolactone, and tetrahydrofuran.
